(19) United States
(12) Patent Application Publication
(10) Pub. No.: US 2007/0067369 A1
(43) Pub. Date: Mar. 22, 2007

(54) Method and system for quantifying and comparing workload on an application server

(76) Inventor: Robbie J. Minshall, Chapel Hill, NC (US)

Correspondence Address: IBM CORP. (RALEIGH SOFTWARE GROUP);c/o Rudolf O Siegesmund Gordon & Rees, LLP, 2100 Ross Avenue, Suite 2600, DALLAS, TX, 75201, US

(21) Appl. No.: 11/232,647

(22) Filed: Sep. 22, 2005

(51) Int. Cl. G06F 17/30

(52) U.S. Cl. 707/205

(57) ABSTRACT

A workload identifier program works in conjunction with an autonomic manager to calculate a workload representation during a pre-determined interval, calculate a similarity metric for the current workload representation by comparing the current workload representation to workload representations during the previous pre-determined intervals, comparing the similarity metric to a threshold value, and responsive to a determination that the similarity metric exceeds the threshold value, either: (1) issuing notifications to the autonomic manager so that the autonomic manager will ignore a plurality of data points and tune the application server with pre-determined recommendations designed for the dramatically increased workload (if the autonomic manager is a runtime autonomic manager), or (2) providing notification to the administrator about the dramatic increase in workload conditions by changing the color of the current interval (if the autonomic manager is a graphical autonomic manager).

### FIELD OF THE INVENTION

The present invention relates to electrical computer data processing in general, and, specifically, to monitoring and analysis of application server workload.

### BACKGROUND OF THE INVENTION

Application servers provide services to clients on a network or the World Wide Web through service providers. When a client asks an application server to run a program or provide data, it is called a service request. Different types of service requests require different service provider resources, and as the number of requests increase, the demands on service provider resources increase. Service provider resources may include, without limitation, central processing units, memory, thread pools, connection pools and session caches. Application servers run a resource allocation program, called an autonomic manager, to allocate system resources to the service providers.

Autonomic managers record the number and type of service requests. The autonomic manager analyzes historical trends based upon data points in the service requests in order to predict the number and type of service requests the application server will have in the future. Using this workload prediction, the autonomic manager recommends ways to optimize allocation of the system resources to the service providers. The optimizing and reallocating of system resources is known as tuning.

United States Patent Application US 2004/0054780 discloses an autonomic manager that measures and calculates the workload on a server cluster by analyzing the number and type of requests associated with each application in use. When the autonomic manager determines the workload is low, servers are removed from service, and when the load increases, servers are added into service. The manager can also change what application is running on specific servers if the load on one application increases and the load on another application decreases. The autonomic manager compares the current workload on the cluster to a predefined standard to determine whether the workload is high or low.

Optimization recommendations from an autonomic manager are based upon historical trend analysis of workload data. When the load is constant, or when the changes in load occur gradually, the historical trend analysis provides satisfactory indications. But, in a situation where the workload changes dramatically the optimization recommendations will be based primarily on analysis of old workload data that may not be applicable to the current workload. Thus, in instances where the workload changes dramatically, the historical trend analysis of workload data may be misleading or inaccurate and prevent an improved allocation of resources to handle the new workload patterns.

A need exists for an autonomic manager that can recognize dramatic changes in workload, and upon such recognition, cause the autonomic manager to ignore the data points of the historical trend analysis and either tune the application server in accordance with pre-determined recommendations for the recognized dramatic change, or notify the administrator so that appropriate action can be taken.

### SUMMARY OF THE INVENTION

The invention that meets the need identified above is a workload identifier program that works in conjunction with an autonomic manager, a configuration program, a rules file, a factors file, a weights file, an integer file and a threshold file.

The autonomic manager retrieves appropriate factors from the factors file, monitors assigned servers, calculates data points for the retrieved factors, and compares the data points for each factor to one or more applicable rules in the rules file. If one or more rules in the rules file call for a change in resource allocation, the AM issues instructions for re-allocation of the resource specified by the rule. The configuration program ensures entry of a threshold value in the threshold file, selection of weighted factors or integer factors, and identification of whether the autonomic manager is a runtime autonomic manager or a graphical autonomic manager.

The workload identifier program retrieves the most recent factor values for a selected application server from storage, calculates a workload representation for the selected application server during a pre-determined interval, calculates a similarity metric for the current workload representation by comparing the current workload representation to workload representations during the previous predetermined intervals, compares the similarity metric to the threshold value from the threshold file, and responsive to a determination that the similarity metric exceeds the threshold value, recognizes the current interval as a dramatically increased workload. Upon recognizing the current interval as a dramatically increased workload, the workload identifier program either: (1) issues notifications to the autonomic manager so that the autonomic manager will ignore the data points and tune the application server with pre-determined recommendations designed for the dramatically increased workload (if the autonomic manager is a runtime autonomic manager), or (2) provides notification to the administrator about the dramatic increase in workload conditions by changing the color of the current interval (if the autonomic manager is a graphical autonomic manager).

### BRIEF DESCRIPTION OF DRAWINGS

The novel features believed characteristic of the invention are set forth in the appended claims. The invention itself, however, as well as a preferred mode of use, further objectives and advantages thereof, will be understood best by references to the following detailed description of an illustrative embodiment when read in conjunction with the accompanying drawings, wherein:

FIG. 1 illustrates an application server connected to a network.

FIG. 2 illustrates the components of the workload identifier program in a storage.

FIG. 3 is a flowchart of the autonomic manager.

FIG. 4 is a flowchart of the configuration program.

FIG. 5 is a flowchart of the workload identifier program.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing login operations on, storing, or displaying data, and includes without limitation processors and memory; the term “computer software” or “software,” refers to any set of instructions operable to cause computer hardware to perform an operation. The term “computer,” as used herein, includes without limitation any useful combination of hardware and software, and a “computer program” or “program” includes without limitation any software operable to cause computer hardware to accept, perform logic operations on, store or display data. A computer program may, and often is, comprised of a plurality of smaller programming units, including without limitation subroutines, modules, functions, methods and procedures. Thus, the functions of the present invention may be distributed among a plurality of computers and computer programs. The invention is described best, though, as a single computer program that configures and enables one or more general purpose computers to implement the novel aspects of the invention. For illustrative purposes, the inventive computer program will be referred to as the “workload identifier program.”

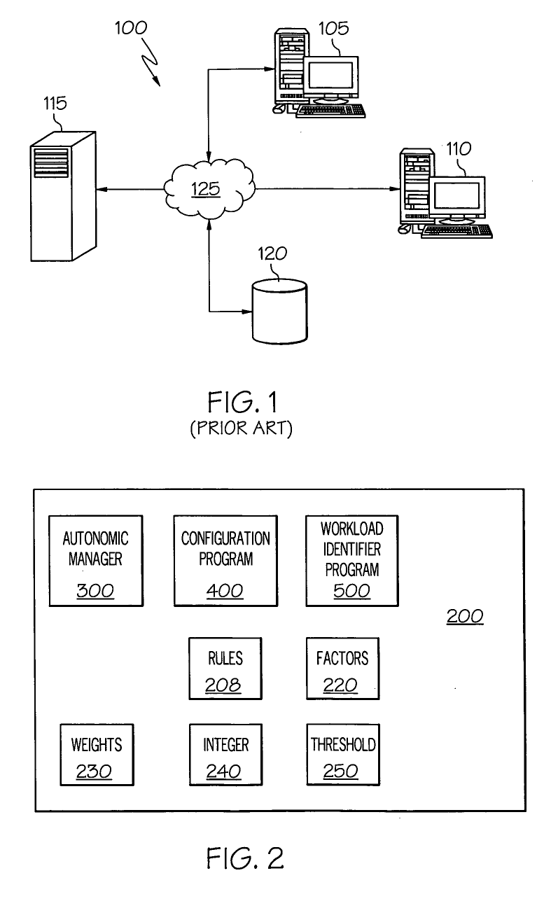

Additionally, the workload identifier program is described below with references to an exemplary network of hardware devices, as depicted in FIG. 1. A “network”0 comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including workstation computer 105, workstation computer 110, server computer 115, and persistent storage 120. Network connection 125 comprises all hardware, software, and communications media necessary to enable communication between network nodes 105-120. Unless otherwise indicated in context below, all network nodes use publicly available protocols or messaging services to communicate with each other through network connection 125.

Referring to FIG. 2, workload identifier program 500 typically resides in storage, represented schematically as storage 200 in FIG. 2. The term “storage,” as used herein, includes without limitation any volatile or persistent medium, such as an electrical circuit, magnetic disk, or optical disk, or a memory in which a computer can store data or software for any duration. A single storage may encompass and be distributed across a plurality of media. Thus, FIG. 2 is included merely as a descriptive expedient and does not necessarily reflect any particular physical embodiment of storage 200. Storage 200 may include additional data and programs. Of particular import to workload identifier 500, storage 200 may include autonomic manager 300, configuration program 400, rules file 208, factors file 220 weights file 230, integer file 240, and threshold file 250. Rules file 208 contains a first set of rules that will be analyzed by autonomic manager 300 in response to data points generated by autonomic manager 300, and a second set of rules that will be analyzed by workload identifier program 500 when a dramatic workload is recognized. Factors file 220 contains the factors for which autonomic manager 300 will monitor assigned servers and calculate data points. Examples of factors include, without limitation, total number of requests per second, requests per second for each application component, database connection requests per second, central processing unit usage, and the number of active applications. Weights file 230 contains weights to be assigned to each of the factors in factors file 220 by workload identifier program 500 when configured to use weighted factors in formulating a workload representation. Integer file 240 contains integer array formats to be used by workload identifier program 500 when configured to use integer factors in formulating a workload representation. Threshold file 250 contains a first set of threshold values for weighted factor workload representations and a second set of threshold values for integer workload representations.

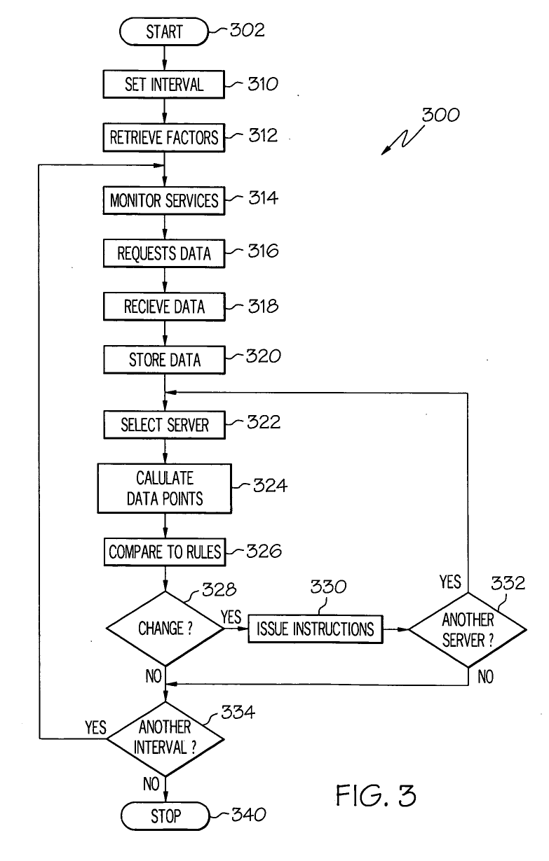

Referring to FIG. 3, autonomic manager 300 starts (302), sets an interval (310), and retrieves selected factors from factors file 220 (312). Autonomic manager 300 monitors assigned application servers (314), requests data for each selected factor from each of the selected application servers (316), receives the data from the selected application servers (318), and stores the data (320). Autonomic manager 300, selects an application server (322), calculates data points for the values for each of the factors (324), uses these data points to analyze rules in rules file 208 (326), determines whether a change is to be made based upon the results of rules analysis (328). If one or more rules in rules file 208 call for a change in resource allocation, autonomic manager 300 issues instructions for re-allocation of the resource specified by the rule (330). Autonomic manager 300 determines whether there is another application server (332), and if so, goes to step 322. If not, autonomic manager 300 determines whether there is another interval (334), and if so, goes to step 314, or if not, stops (340).

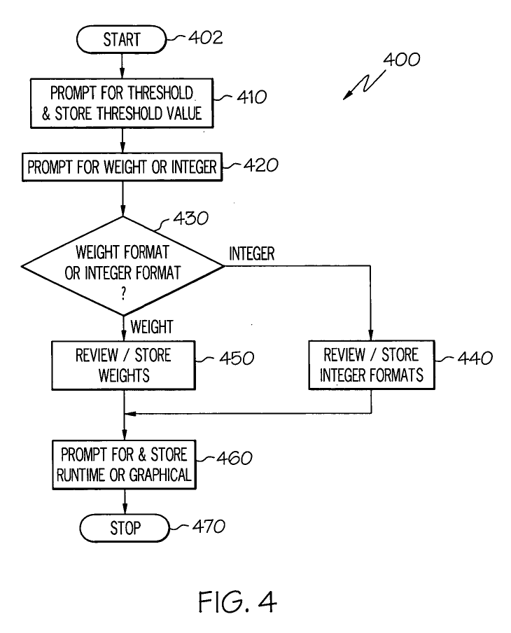

FIG. 4 depicts a flow chart for configuration program 400. Configuration program 400 starts (402) and prompts the user to enter one or more threshold values, and stores the threshold values in threshold file 250 (410). Configuration program 400 prompts the user to select a weighted format or an integer format (420). Configuration program 400 determines whether the user selected weighted format or integer format (430). If the user chose weighted format, configuration program 400 prompts the user to review the current weights applied to each of the factors and make any changes that may be desired (450). If the user chose integer format, configuration program 400 prompts the user to review the current integer formats and make any changes that may be desired (440). Configuration program 400 prompts the user to indicate whether autonomic manager 300 is a runtime autonomic manager or a graphical autonomic manager (460). Configuration program 400 stops (470).

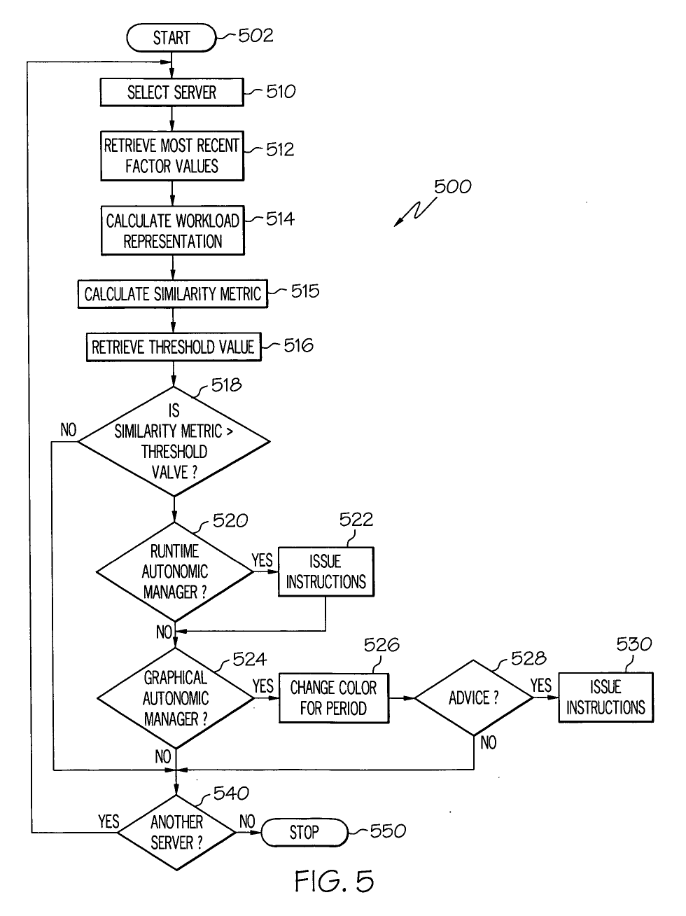

FIG. 5 depicts a flow chart for workload identifier program 500. Workload identifier program 500 starts (502), selects a server for examination (510), and retrieves the most recent factor values for the selected application server from storage 210 (512). Using the most recent factor values, workload identifier program 500 calculates a workload representation for the selected server (514).

Workload identifier program 500 may calculate the workload representation in two ways, depending on whether the user configured workload identifier program 500 to use a weighted factor data structure or an integer array format. If configured for a weighted factor data structure, workload identifier program 500 calculates the workload representation as a set of weighted factor values by placing the most recent factor values for the application server in a standard data structure, retrieving the weights for each factor from weights file 230, and applying the appropriate weight to each of the factor values in the data structure. Suitable standard data structures include without limitation a matrix, or a multiple variable vector. If configured for an integer array format, workload identifier program 500 calculates the workload representation by retrieving an integer array format from integer file 240 and placing the most recent factor values for the application server, into the integer array format.

When using an integer array format, the integer array format preferably comprises a byte array divided into equal subsections. For example, a byte array having 16 bits may be divided into four subsections sections each containing 4 bits. Division of a byte array limits the number of factors that may be represented in the array; however, this limitation may be overcome by combining similar factors within a single sub-section of the byte array. Each subsection represents a factor. Subsections may be given different weights based upon location in the array, and factors may then be assigned a weight based upon the factors placement in the array. The values of the byte array sub-sections represent the weight of that factor. For example, if one factor was central processing unit (cpu) usage with a maximum value of 15, and the cpu usage factor was 20% of the cpu capacity, the value of 15 may be represented as the byte array 1111, and the factor representing 20% usage would be set to 3, represented by the byte array 0011. Using byte arrays, the workload identifier program can represent a complex workload representation as a small integer set that can be compared so that the similarity of the integer representation would be proportional to the similarity of the weighted factors

500 takes the current workload representation and calculates a similarity metric (515). As used herein, the term similarity metric means a value derived by comparing the workload representation for the current interval to the stored workload representation values for each of the previous intervals (515). When using weighted factors, workload identifier program 500 calculates a standard mathematical similarity metric for the data structure. When using integer factors, workload identifier 500 determines the similarity metric by calculating the percentage difference of the integer values representing the workload representation being compared. The threshold value for a weighted factor comparison comprises the valid bounds for the similarity metric and depends upon the specific similarity metric computation utilized. The threshold for a integer factor comparison would be the maximum allowed percentage difference.

Workload identifier program 500 retrieves the threshold value from threshold file 250 (516), and determines whether the similarity metric is greater than the threshold value (518). If the threshold value is exceeded, workload identifier 500 determines whether autonomic manager 300 is a runtime autonomic manager, or a graphical autonomic manager (520). If autonomic manager 300 is a runtime autonomic manager, workload identifier program 500 instructs autonomic manager 300 to ignore all data points and to only examine the most recent interval (522). Additionally, workload identifier program 500 instructs autonomic manager 300 to cancel any pending tuning instructions. Workload identifier program 500 determines whether autonomic manager 300 is a graphical autonomic manager (524), and if so, workload identifier program 500 changes the background color of the current period with the workload on the graphical display to identify the change in workload to the administrator, so that the administrator may make reallocations (526). Workload identifier program 500 determines whether the user desires advice (528) and if so, workload identifier program 500 instructs autonomic manager 300 to provide re-allocation recommendations to the user (530). Workload identifier program 500 determines whether there is another server (540), and if so goes to step 510, or if not, stops (550).

A preferred form of the invention has been shown in the drawings and described above, but variations in the preferred form will be apparent to those skilled in the art. The preceding description is for illustrative purposes only, and the invention should not be construed as limited to the specific form shown and described. The scope of the invention should be limited only by the language of the following claims.

What is claimed is:

1. An apparatus comprising:
a plurality of computers connected by a network;
a storage connected to one of the plurality of computers;
an autonomic manager program and a workload identifier program residing in the storage;
wherein the autonomic manager program retrieves a plurality of data from the plurality of computers corresponding to a plurality of factors during each of a plurality of time periods, stores the plurality of data, and calculates data points for each of the factors during each of the plurality of time periods; and
wherein the workload identifier program calculates and stores a plurality of workload representations for each of a plurality of intervals, calculates a similarity metric for a workload representation for a current time interval, and compares the similarity metric to a threshold value, and if the similarity metric for the most recent time interval exceeds the threshold value, issues an instruction.

2. The apparatus of claim 1 the autonomic manager retrieves selected factors from a factors file, monitors a plurality of assigned servers, requests data for each selected factor from each of the assigned servers, receives the data from the assigned servers, stores the data, calculates a plurality of data points for each of the factors, analyzes a plurality of rules based on the plurality of data points, so that if a rule calls for a change in resource allocation, the autonomic manager issues instructions for re-allocation of the resource as specified by the rule.

3. The apparatus of claim 1 further comprising a configuration program that prompts the user to enter a threshold value in a threshold file, to select a weighted format or an integer format, and prompts the user to designate whether the autonomic manager is a runtime autonomic manager or a graphical autonomic manager.

4. The apparatus of claim 1 wherein the workload identifier program further comprises: selecting an application server for examination, retrieving the most recent factor values for the selected application server, using the most recent factor values, calculating a workload representation for the selected application server, calculating a similarity metric for the workload representation, retrieving the threshold value, comparing the similarity metric to the threshold value, and responsive to determining that the threshold value is exceeded, issuing an instruction.

5. The apparatus of claim 4 wherein, responsive to determining that the autonomic manager is a runtime autonomic manager, the action is sending an instruction to the autonomic manager to ignore the data points.

6. The apparatus of claim 4 wherein responsive to determining that the autonomic manager is a graphical autonomic manager, the action is changing the background color of the current time interval.

7. The apparatus of claim 4 further comprising an instruction to the autonomic manager to cancel a pending server tuning operation.

8. A computer implemented process comprising:
using an autonomic manager program,
retrieving a plurality of data from the plurality of computers corresponding to a plurality of factors during each of a plurality of time periods;
storing the plurality of data;
calculating a plurality of data points for each of the factors during each of the plurality of time periods;
using an workload identifier program,
calculating a workload representation for each computer for each of the plurality of time intervals;
calculating a similarity metric for a workload representation for a most recent interval;
comparing the similarity metric for the most recent interval to a threshold value; and
responsive to the similarity metric for the most recent time interval exceeding the threshold value, issuing an instruction.

9. The computer implemented process of claim 8 further comprising:
using the workload identifier program, issuing an instruction to ignore the plurality of data points.

10. The computer implemented method of claim 9 further comprising:
issuing an instruction to cancel a pending tuning operation based on the plurality of data points.

11. The computer implemented process of claim 8 further comprising:
using a configuration program, prompting the user to enter a threshold value in a threshold file, to select weighted factors or integer factors, and to designate whether the autonomic manager is a runtime autonomic manager or a graphical autonomic manager.

12. The computer implemented process of claim 8 further comprising:
selecting an application server for examination;
storing a plurality of factor values for a plurality of time intervals;
retrieving a set of most recent factor values for the selected application server;
using the set of most recent factor values, calculating a workload representation for the selected server;
calculating a similarity metric for the workload representation;
retrieving the threshold value;
comparing the similarity metric to the threshold value; and
responsive to determining that the threshold value is exceeded, issuing an instruction.

13. The computer implemented process of claim 8 further comprising:
responsive to determining that the autonomic manager is a runtime autonomic manager, sending an instruction to the autonomic manager to ignore a plurality of data points for a plurality of time intervals.

14. The computer implemented process of claim 8 further comprising:
responsive to determining that the autonomic manager is a graphical autonomic manager, changing the background color of the current time interval.

15. The computer implemented process of claim 8 further comprising:
an instruction to the autonomic manager to cancel a pending server tuning operation.

16. A computer program product for comprising:
instructions for causing a computer to
select an application server for examination;
retrieve the most recent factor values for the selected server;
using the most recent factor values, calculate a workload representation for the selected server;
calculate a similarity metric for the workload representation;
retrieve the threshold value;
compare the similarity metric to the threshold value; and
responsive to determining that the threshold value is exceeded, issue an instruction to an autonomic manager program;
wherein the computer program product is adapted for cooperation with the autonomic manager program.
